(19) United States
(12) Patent Application Publication
(10) Pub. No.: US 2017/0368480 A1
(43) Pub. Date: Dec. 28, 2017

(54) Selective Flocculants for Mineral Ore Benefication

(71) Applicant: KEMIRA OYJ, Helsinki (FI)

(72) Inventors: Lucas Moore, Dover, FL (US); Xihui Yin, Atlanta, GA (US); Jean Robert Durand, Atlanta, GA (US); Marcelo Moreira da Costa, Barueri (BR)

(21) Appl. No.: 15/538,446

(22) PCT Filed: Dec. 18, 2015
(86) PCT No.: PCT/US2015/066718

§ 371 Date: Jun. 21, 2017

Related U.S. Application Data
(60) Provisional application No. 62/096,307, filed on Dec. 23, 2014.

(51) Int. Cl. B01D 21/01; C08L 33/02; C08F 220/56; C08L 33/26; B03D 3/06

(52) U.S. Cl. CPC B01D 21/01; C08L 33/26; B03D 3/06; C08F 220/56; C08L 33/02

(57) ABSTRACT

Selective flocculants comprise a polymer comprising recurring units of one or more acrylamide monomers; recurring units of one or more monomers selected from hydroxyalkyl alkylacrylate, allyloxyalkyldiol, allyloxyethanol, trimethylolpropane allyl ether, and 2-hydroxy ethyl acrylate; and optionally, recurring units of one or more acrylic acid monomers. Also disclosed are processes for enriching a desired mineral from an ore comprising the desired mineral and gangue, wherein the process comprises carrying out a selective flocculation process in the presence of one or more of the selective flocculants.

### CROSS-REFERENCE TO RELATED APPLICATION

This application claims priority to U.S. Provisional Application No. 62/096,307, filed Dec. 23, 2014.

### FIELD OF THE ART

The present invention relates to selective flocculants for fine particles present during the beneficiation of mineral ores.

### BACKGROUND

Although iron is the fourth most abundant element in the Earth's crust, the vast majority is bound in silicate, or more rarely, carbonate minerals. The thermodynamic barriers to separating pure iron from these minerals are formidable and energy intensive, therefore common sources of iron used by industry exploit comparatively rarer high-grade iron oxide minerals, primarily hematite. Most reserves of such high-grade ore have now been depleted, leading to development of lower-grade iron ore sources, for example, magnetite and taconite. The iron content of these lower-grade ores may be concentrated (upgraded) to a higher iron content through various concentration (beneficiation) processes, for example, to meet the quality requirement of iron and steel industries.

In the face of dwindling reserves of high grade iron ores, it is expected that greatly increased tonnage of lower-grade iron ores will be recovered in the foreseeable future. The processing of lower grade ore sources involves the removal of unwanted minerals (such as silicates and carbonates) which are an intrinsic part of the ore rock itself (gangue). In these beneficiation processes, the gangue is separated using techniques like crushing, grinding, milling, gravity or heavy media separation, screening, magnetic separation, and/or froth flotation to improve the concentration of the desired minerals and remove impurities.

Despite the improvements in recovery and concentration of desired minerals provided by the various beneficiation processes, losses of the valuable ore are still incurred during processing, for example, in the desliming stage (for instance, by filtration, settling, syphoning or centrifuging) used to eliminate the finest fraction of particulates. Significant amounts of fine particulate valuable ore that remains dispersed may be lost in the slime fraction. That portion of the valuable mineral or minerals that is inadvertently removed with the slime fraction may be permanently lost from the process. Even a small increase in the recovery or grade of desired mineral or minerals can result in significant economic benefits.

In an effort to improve valuable ore recovery, a modified flotation system was developed which involved a pre-conditioning of the ores by dispersing the finely ground ore in an aqueous medium and initially subjecting it to a selective flocculation process. Following the selective flocculation stage, the system is deslimed to remove the silica-bearing fines and the flocculated iron-containing residues are then concentrated to final grade by flotation and removal of the non-ferrous siliceous material. In selective flocculation, the flocculants are added prior to the flotation and desliming stages and are selective in their flocculating properties so as to effectuate a separation between mineral species contained in the aqueous dispersion. In an oxidized iron ore system, the selective flocculant causes the flocculation of iron containing particles while leaving the non-ferrous siliceous materials in suspension.

Selective flocculants presently known in the art include tapioca flour, potato starch, natural and modified starches, and polyacrylamides and synthetic flocculants, for example, as taught in U.S. Pat. No. 3,292,780, to Frommer et al. U.S. Pat. No. 4,081,357, to Werneke et al., U.S. Pat. No. 4,274,945, and European Patent No. 0232679 B 1.

### BRIEF SUMMARY

In view of the foregoing, one or more embodiments described herein include selective flocculants comprising a polymer comprising a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers. Also described herein are compositions comprising the selective flocculants, as well as processes for enriching a desired mineral from an ore having the desired mineral and gangue, wherein the process comprises carrying out a flocculation process in the presence of one or more exemplary selective flocculants.

The disclosure may be understood more readily by reference to the following detailed description of the various features of the disclosure and the examples included therein.

### BRIEF DESCRIPTION OF FIGURES

FIG. 1 shows the effect of an exemplary selective flocculant on the turbidity of pure iron oxide samples and silica samples.

### DETAILED DESCRIPTION

According to the various exemplary embodiments described herein, selective flocculants may be used to improve the grade and/or recovery of valuable minerals from mineral-containing ore. Exemplary processes use the exemplified selective flocculants to selectively flocculate iron or other mineral values from their associated siliceous gangue, and more specifically to selectively flocculate an oxidized iron ore from its associated siliceous gangue. In exemplary embodiments, the process comprises dispersing a finely ground ore in an aqueous medium, and adding an effective amount of one or more selective flocculants described herein.

In exemplary embodiments, the selective flocculant comprises a polymer comprising: a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers. In exemplary embodiments, the selective flocculant is a polymer comprising: a) recurring units of one or more acrylamide monomers; b) recurring units of one or more hydroxyalkyl alkylacrylate monomers; and optionally, c) recurring units of one or more acrylic acid monomers.

In exemplary embodiments, the selective flocculant comprises a polymer comprising: a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and c) recurring units of one or more acrylic acid monomers. In exemplary embodiments, the selective flocculant comprises a polymer comprising: a) recurring units of one or more acrylamide monomers; b) recurring units of one or more hydroxyalkyl alkylacrylate monomers; and c) recurring units of one or more acrylic acid monomers.

In exemplary embodiments, the selective flocculants, compositions and processes may be used to provide improved selectivity for the desired mineral compared to other flocculants such as starch or causticized starch. In particular, the selective flocculants may provide increased desliming selectivity, decreased valuable ore fines loss, decreased sodium hydroxide consumption, and/or decreased landfill, especially as compared to starch-based flocculants. The exemplary selective flocculants may also offer an advantage over starch-based selective flocculants because they do not have food value.

Definitions

As used herein, “gangue” or “siliceous gangue” refers to the undesirable minerals in a material, for example, an ore deposit that contains both undesirable and desired minerals. Such undesirable minerals may include oxides of aluminum, silica (e.g. quartz), titanium, sulfur and alkaline earth metals and the like. In exemplary embodiments, the gangue includes oxides of silica (e.g. SiO₂ or quartz), silicates or siliceous materials such as kaolinite, muscovite, smectite and the like.

As used herein, the terms “desired minerals” or “minerals of value” refer to any minerals (naturally occurring solid inorganic substances) that have value, and in particular, may be extracted from ore that contains the desired mineral and gangue. Examples of desired minerals include iron powder, hematite, magnetite, pyrite, chromite, goethite, marcasite, limonite, pyrrhotite or any other iron-containing minerals. As used herein, “ore” refers to rocks and other deposits from which the desired minerals can be extracted. Other sources of the desired minerals may be included in the definition of “ore” depending on the identity of the desired mineral. The ore typically contains undesirable minerals or materials, also referred to herein as gangue.

As used herein, “iron ore” refers to rocks, minerals and other sources of iron from which metallic iron can be extracted. The ores are usually rich in iron oxides and vary in color from dark grey, bright yellow, deep purple, to rusty red. The iron is usually found in the form of magnetite (Fe₃O₄), hematite (Fe₂O₃), goethite (FeO(OH)), limonite (FeO(OH).n(H₂O)), siderite (FeCO₃) or pyrite (FeS₂). Taconite is an iron-bearing sedimentary rock in which the iron minerals are interlayered with quartz, chert, or carbonate. Itabirite, also known as banded-quartz hematite and hematite schist, is an iron and quartz formation in which the iron is present as thin layers of hematite, magnetite, or martite. Any of these types of iron are suitable for use in processes described herein. In exemplary embodiments, the iron ore is substantially magnetite, hematite, taconite or itabirite. In exemplary embodiments, the iron ore is substantially pyrite. In exemplary embodiments, the iron ore is contaminated with gangue materials, for example, oxides of aluminum, silica or titanium. In exemplary embodiments, the iron ore is contaminated with gangue. In exemplary embodiments, the iron ore is contaminated with clay, including, for example, kaolinite, muscovite or other silicates.

As used herein, a “pH adjuster” or “pH regulator” refers to an agent that is used to change or control pH. Any suitable agent that is used to change or control pH may be used, including, for example, sodium hydroxide or ammonium hydroxide.

As used herein, the terms “polymer,” “polymers,” “polymeric,” and similar terms are used in their ordinary sense as understood by one skilled in the art, and thus may be used herein to refer to or describe a large molecule (or group of such molecules) that contains recurring units. Polymers may be formed in various ways, including by polymerizing monomers and/or by chemically modifying one or more recurring units of a precursor polymer. Unless otherwise specified, a polymer may be a “homopolymer” comprising substantially identical recurring units formed by, e.g., polymerizing a particular monomer. Unless otherwise specified, a polymer may also be a “copolymer” comprising two or more different recurring units formed by, e.g., copolymerizing two or more different monomers, and/or by chemically modifying one or more recurring units of a precursor polymer. Unless otherwise specified, a polymer may also be a “terpolymer” comprising three or more different recurring units.

As used herein, a “flocculant” or “selective flocculant” refers to an agent that facilitates the agglomeration of particles in a suspension (such as a dispersed suspension). In particular, a selective flocculant selectively enriches one fraction isolated from a flocculation process with the desired mineral while a second fraction is enriched in gangue. In exemplary embodiments, the selective flocculant is an agent that selectively enriches one fraction isolated from a flocculation process with the iron or iron oxide while a second fraction is enriched in gangue.

Selective Flocculants

In exemplary embodiments, the one or more selective flocculants may be selective in the flocculation of ultrafine aqueous dispersions of metal ores, in particular, iron ores or other desirable minerals. In exemplary embodiments, the one or more selective flocculants do not substantially flocculate gangue materials. The simultaneous presence of desirable minerals that can be separated by flocculation and of gangue materials does not alter substantially the flocculation potential of the minerals. In exemplary embodiments, the amount of flocculation achieved is at least about 40%, about 45%, about 50%, about 55%, about 60%, about 65%, about 70%, about 75%, about 80%, about 85%, or about 90% of the desired mineral in the aqueous medium. In exemplary embodiments, the amount of flocculation achieved is in the range of about 40% to about 90%, about 40% to about 60%, or about 45% to about 55% of the desired mineral in the aqueous medium.

In exemplary embodiments, the one or more selective flocculants comprises a polymer comprising: a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers. In exemplary embodiments, the polymer comprises recurring units of one or more acrylic acid monomers. In exemplary embodiments, the one or more selective flocculants comprises a polymer comprising: a) recurring units of one or more acrylamide monomers; b) recurring units of one or more hydroxyalkyl alkylacrylate monomers; and optionally, c) recurring units of one or more acrylic acid monomers. In exemplary embodiments, the one or more selective flocculants consists essentially of, or is, a polymer comprising: a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers. In exemplary embodiments, the one or more selective flocculants consists essentially of, or is, a polymer comprising: a) recurring units of one or more acrylamide monomers; b) recurring units of one or more hydroxyalkyl alkylacrylate monomers; and optionally, c) recurring units of one or more acrylic acid monomers.

In various exemplary embodiments, the polymer may include one or more additional monomers. The one or more additional monomers may be any other suitable monomer, provided the selective flocculant retains the desired functionality described herein.

In exemplary embodiments, the one or more selective flocculants comprises a polymer consisting essentially of: a) recurring units of one or more acrylamide monomers; and b) recurring units of one or more hydroxyalkyl alkylacrylate monomers. In exemplary embodiments, the one or more selective flocculants comprises a polymer consisting essentially of: a) recurring units of one or more acrylamide monomers and b) recurring units of hydroxyethyl methylacrylate monomers.

In exemplary embodiments, the one or more selective flocculants comprises a polymer consisting essentially of: a) recurring units of one or more acrylamide monomers b) recurring units of one or more monomers selected from hydroxyalkyl alkylacrylate, allyloxyalkyldiol, allyloxyethanol, trimethylolpropane allyl ether, and 2-hydroxy ethyl acrylate; and c) recurring units of one or more acrylic acid monomers. In exemplary embodiments, the one or more selective flocculants comprises a polymer consisting essentially of: a) recurring units of one or more acrylamide monomers b) recurring units of one or more hydroxyalkyl alkylacrylate monomers; and c) recurring units of one or more acrylic acid monomers. In exemplary embodiments, the one or more selective flocculants comprises a polymer consisting essentially of: a) recurring units of one or more acrylamide monomers; b) recurring units of hydroxyethyl methylacrylate monomers; and c) recurring units of one or more acrylic acid monomers.

In exemplary embodiments, the recurring units in the polymer comprise any proportion of the one or more acrylamide monomers, one or more monomers selected from hydroxyalkyl alkylacrylate, allyloxyalkyldiol, allyloxyethanol, trimethylolpropane allyl ether, and 2-hydroxy ethyl acrylate, and/or one or more acrylic acid monomers, as long as the proportions of the monomer are such that the performance of the polymer as a selective flocculant is not substantially diminished or compromised.

In exemplary embodiments, the recurring units in the polymer comprise about 10% to about 99%, about 20% to about 99%, about 30% to about 99%, about 40% to about 95%, about 50% to about 95%, about 60% to about 95%, about 70% to about 95%, about 70% to about 80%, about 75% to about 90%, about 75% to about 85%, or about 80% to about 85%, of one or more acrylamide monomers.

In exemplary embodiments, recurring units in the polymer comprise about 3% to about 90%, about 3% to about 80%, about 5% to about 70%, about 5% to about 60%, about 5% to about 50%, about 5% to about 40%, about 5% to about 30%, about 10% to about 30%, about 10% to about 20%, about 18% to about 23%, or about 15% to about 25% of one or more monomers selected from hydroxyalkyl alkylacrylate, allyloxyalkyldiol, allyloxyethanol, trimethylolpropane allyl ether, and 2-hydroxy ethyl acrylate.

In exemplary embodiments, recurring units in the polymer comprise about 3% to about 90%, about 3% to about 80%, about 5% to about 70%, about 5% to about 60%, about 5% to about 50%, about 5% to about 40%, about 5% to about 30%, about 10% to about 30%, about 10% to about 20%, about 18% to about 23%, or about 15% to about 25% of one or more hydroxyalkyl alkylacrylate monomers.

In exemplary embodiments, the recurring units in the polymer comprise about 3% to about 90%, about 5% to about 90%, about 10% to about 90%, about 20% to about 90%, about 30% to about 80%, about 40% to about 75%, about 50% to about 75%, about 3% to about 50%, about 3% to about 10%, about 3% to about 7%, or about 10% to about 40%, of one or more acrylic acid monomers.

In exemplary embodiments, the recurring units in the polymer comprise about 70% to about 95% of the one or more acrylamide monomers and about 5% to about 30% of the one or more monomers selected from hydroxyalkyl alkylacrylate, allyloxyalkyldiol, allyloxyethanol, trimethylolpropane allyl ether, and 2-hydroxy ethyl acrylate.

In exemplary embodiments, the recurring units in the polymer comprise about 75% to about 85% of the one or more acrylamide monomers and about 15% to about 25% of the one or more monomers selected from hydroxyalkyl alkylacrylate, allyloxyalkyldiol, allyloxyethanol, trimethylolpropane allyl ether, and 2-hydroxy ethyl acrylate.

In exemplary embodiments, the recurring units in the polymer comprise about 70% to about 95% of the one or more acrylamide monomers and about 5% to about 30% of the one or more hydroxyalkyl alkylacrylate monomers.

In exemplary embodiments, the recurring units in the polymer comprise about 75% to about 85% of the one or more acrylamide monomers and about 15% to about 25 of the one or more hydroxyalkyl alkylacrylate monomers.

In exemplary embodiments, the one or more acrylamide monomers have been partially hydrolyzed to form the one or more acrylic acid monomers. In exemplary embodiments, the one or more acrylamide monomers are present in the polymers in an amount that is greater than the amount of the one or more acrylic acid monomers.

In exemplary embodiments, the recurring units in the polymer comprise about 5% to about 92% of the one or more acrylamide monomers, about 3% to about 65% of the one or more acrylic acid monomers, and about 5% to about 30% of the one or more monomers selected from hydroxyalkyl alkylacrylate, allyloxyalkyldiol, allyloxyethanol, trimethylolpropane allyl ether, and 2-hydroxy ethyl acrylate.

In exemplary embodiments, the recurring units in the polymer comprise about 25% to about 92% of the one or more acrylamide monomers, about 25% to about 65% of the one or more acrylic acid monomers, and about 5% to about 30% of the one or more monomers selected from hydroxyalkyl alkylacrylate, allyloxyalkyldiol, allyloxyethanol, trimethylolpropane allyl ether, and 2-hydroxy ethyl acrylate.

In exemplary embodiments, the recurring units in the polymer comprise about 10% to about 82% of the one or more acrylamide monomers comprise, about 3% to about 65% of the one or more acrylic acid monomers, and about 15% to about 25% of the one or more monomers selected from hydroxyalkyl alkylacrylate, allyloxyalkyldiol, allyloxyethanol, trimethylolpropane allyl ether, and 2-hydroxy ethyl acrylate.

In exemplary embodiments, the recurring units in the polymer comprise about 5% to about 92% of the one or more acrylamide monomers, about 3% to about 65% of the one or more acrylic acid monomers, and about 5% to about 30% of the one or more hydroxyalkyl alkylacrylate monomers.

In exemplary embodiments, the recurring units in the polymer comprise about 25% to about 92% of the one or more acrylamide monomers, about 25% to about 65% of the one or more acrylic acid monomers, and about 5% to about 30% of the one or more hydroxyalkyl alkylacrylate monomers.

In exemplary embodiments, the recurring units in the polymer comprise about 10% to about 82% of the one or more acrylamide monomers comprise, about 3% to about 65% of the one or more acrylic acid monomers, and about 15% to about 25% of the one or more hydroxyalkyl alkylacrylate monomers.

In exemplary embodiments, the recurring units in the polymer comprise about 70% to about 80% of the one or more acrylamide monomers comprise, about 3% to about 10% of the one or more acrylic acid monomers, and about 15% to about 25% of the one or more monomers selected from hydroxyalkyl alkylacrylate, allyloxyalkyldiol, allyloxyethanol, trimethylolpropane allyl ether, and 2-hydroxy ethyl acrylate.

In exemplary embodiments, the recurring units in the polymer comprise about 70% to about 80% of the one or more acrylamide monomers comprise, about 3% to about 10% of the one or more acrylic acid monomers, and about 15% to about 25% of the one or more hydroxyalkyl alkylacrylate monomers.

In exemplary embodiments, the recurring units in the polymer comprise about 70% to about 80% of the one or more acrylamide monomers comprise, about 3% to about 10% of the one or more acrylic acid monomers, and about 15% to about 25% of the one or more hydroxyethyl methacrylate monomers.

In exemplary embodiments, the recurring units in the polymer comprise about 75% of the one or more acrylamide monomers comprise, about 5% of the one or more acrylic acid monomers, and about 20% of the one or more hydroxyalkyl alkylacrylate monomers.

An exemplary acrylamide monomer may be an acrylamide or substituted acrylamide, for example methacrylamide, N-methylol acrylamide, N,N-dimethylacrylamide, N-vinyl formamide, vinylhexanamide, 2-acrylamido-2-methylpropane sulfonic acid, and the like.

In exemplary embodiments, the polymer comprises one or more hydroxyalkyl alkylacrylate monomers. In exemplary embodiments, the polymer comprises one or more allyloxyalkyldiol monomers. In exemplary embodiments, the polymer comprises one or more allyloxyethanol monomers. In exemplary embodiments, the polymer comprises one or more trimethylolpropane allyl ether monomers. In exemplary embodiments, the polymer comprises one or more 2-hydroxy ethyl acrylate monomers.

In exemplary embodiments, a hydroxyalkyl alkylacrylate monomer comprises a hydroxyalkyl moiety and an alkylacrylate moiety.

In exemplary embodiments, an alkyl group is selected from a C₁₋₆ linear or branched alkyl group, for example methyl, ethyl, propyl, butyl, pentyl, hexyl and all constitutional isomers of such alkyl groups. In exemplary embodiments, the hydroxyalkyl moiety is for example, hydroxymethyl, hydroxyethyl, hydroxypropyl, hydroxybutyl, hydroxypentyl, hydroxyhexyl and the like. In exemplary embodiments, the hydroxyl group may be a hydroxyl or the protonated or ionized forms of a hydroxyl, such as an alkali metal salt or ammonium salt of a hydroxyl. In exemplary embodiments, the allyloxyalkyldiol monomer is for example, allyloxymethyldiol, allyloxyethyldiol, allyloxypropyldiol, allyloxybutyldiol, allyloxypentyldiol, allyloxyhexyldiol, and the like.

In exemplary embodiments, the alkylacrylate moiety is for example, methylacrylate, ethylacrylate, propylacrylate, butylacrylate, pentylacrylate, hexylacrylate and the like.

An exemplary hydroxyalkylmethacrylate monomer includes, for example 2-hydroxyethyl methacrylate; 2, 3-dihydroxypropyl methacrylate; and 3-hydroxy propyl methacrylate. In exemplary embodiments, the one or more hydroxyalkyl alkylacrylate monomers comprises hydroxyethyl methylacrylate. In exemplary embodiments, the one or more hydroxyalkyl alkylacrylate monomers consist essentially of hydroxyethyl methylacrylate.

In exemplary embodiments, the one or more hydroxyalkyl alkylacrylate monomers are selected from the monomers of Formula I:

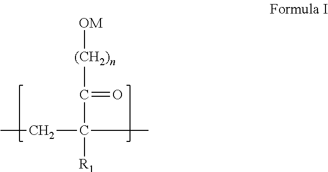

wherein:
R₁ is a C₁₋₆ linear or branched alkyl;
M is selected from the group consisting of H, alkali metal cation or ammonium ion;
and
n is in the range from 1 to 6.

In exemplary embodiments, the selective flocculant may include additional monomers up to about 3%, about 5%, about 10%, about 15%, about 20%, about 25%, or about 30% of the polymer, provided that the polymer retains its desired functionality, as described herein.

In exemplary embodiments, the one or more selective flocculants comprise an acrylamide hydroxyethyl methacrylate polymer. In exemplary embodiments, the one or more selective flocculants consists essentially of an acrylamide hydroxyethyl methacrylate polymer. In alternative embodiments, the one or more selective flocculants comprise a polymer consisting essentially of acrylamide, acrylic acid and hydroxyethyl methacrylate monomers.

In exemplary embodiments, the one or more selective flocculants are not substantially digestible or are not suitable for human consumption.

In exemplary embodiments, the one or more selective flocculants may have any molecular weight so long as the selective flocculants have the effect of selectively flocculating the desired minerals in preference to the associated gangue. In exemplary embodiments, the weight average molecular weight of the flocculant is about 200,000 to about 1,000,000; about 250,000 to about 800,000; about 300,000 to about 700,000; about 300,000 to about 600,000; about 300,000 to about 500,000; about 400,000 to about 600,000, or about 400,000 to about 500,000 Daltons. In exemplary embodiments, the polymer is linear. In exemplary embodiments, the polymer structure may include branched polymers, star polymers, comb polymers, crosslinked polymers, or combinations thereof

In exemplary embodiments, the polymer may be made in accordance with any of a variety of polymerization methods. For example, suitable methods of addition polymerization include, but are not restricted to, free radical polymerization, controlled radical polymerization such as atom transfer radical polymerization, reversible addition-fragmentation chain transfer, nitroxide mediated polymerization, cationic polymerization or an ionic polymerization. In exemplary embodiments, the polymers may be made by radical or controlled radical polymerization methods. Suitable reaction media include but are not restricted to water solution, aqueous solution (comprising water and polarity changing water-soluble organic compounds such as alcohols ethers, esters, ketones and or hydroxy ethers), emulsion, and microemulsion.

Compositions

In exemplary embodiments, a composition comprises one or more selective flocculants, as described herein, and a solvent. In exemplary embodiments, a composition comprises one or more selective flocculants and a solvent, wherein the one or more selective flocculants is one or more of the selective flocculants described herein. In exemplary embodiments, the solvent is water. In exemplary embodiments, the composition is a solution, for example, an aqueous solution.

An exemplary composition may be formulated to provide a sufficient amount of one or more exemplary selective flocculants prior to a desliming process, i.e., an amount sufficient to produce a desired result.

In exemplary embodiments, the composition may further comprise one or more agents or modifiers known in the desliming art, such as dispersants. Examples of such agents or modifiers include, but are not limited to, sodium silicate and/or polyacrylic acid-based dispersants, or any other agent known in the art. Dispersants suitable for use in combination with the exemplary selective flocculants are not particularly limited and include: KemEcal™ TC2500 (a sodium silicate and polyacrylic acid dispersant available from Kemira Chemicals, Inc.), sodium polyphosphate and the like.

In exemplary embodiments, the composition may be used in a process wherein the one or more agents or modifiers known in the desliming art, such as dispersants, are added separately.

In exemplary embodiments, the composition includes one or more conventional selective flocculants or a flocculant not included in the embodiments described herein. Other selective flocculants that may be used in combination with the exemplary flocculants include, but are not limited to: starch, such as tapioca, corn, potato, wheat, rice and the like; starch activated by treatment with alkali; cellulose esters, such as carboxymethylcellulose and sulphomethylcellulose; cellulose ethers, such as methyl cellulose, hydroxyethylcellulose and ethyl hydroxyethylcellulose; hydrophilic gums, such as gum arabic, gum karaya, gum tragacanth and gum ghatti, alginates; starch derivatives, such as carboxymethyl starch and phosphate starch; and combinations thereof.

Processes

In exemplary embodiments, a selective flocculation process comprises dispersing a ground ore in an aqueous medium to form a mixture, and adding one or more exemplary selective flocculants described herein to the mixture. In exemplary embodiments, an effective amount of the one or more selective flocculants is added to the mixture. In exemplary embodiments, the one or more selective flocculants added to the mixture comprises a polymer comprising: a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers. In exemplary embodiments, an effective amount of the one or more selective flocculants is added to the mixture. In exemplary embodiments, the one or more selective flocculants added to the mixture comprises a polymer comprising: a) recurring units of one or more acrylamide monomers; b) recurring units of one or more hydroxyalkyl alkylacrylate monomers; and optionally, c) recurring units of one or more acrylic acid monomers. In exemplary embodiments, the ground ore is ground iron ore or ground iron ore contaminated with gangue.

In exemplary embodiments, the process further comprises, after the one or more selective flocculants has been added to the mixture, vigorously mixing the mixture to ensure uniform distribution of the polymer throughout the mixture. In exemplary embodiments, the process further comprises allowing the iron values to settle from the mixture. For example, the iron values may settle from the mixture as an underflow concentrate while the siliceous gangue material remains suspended in the supernatant liquid. Generally, effective settling is accomplished within about 30 minutes or in the range of about 5 to about 30 minutes, after the one or more selective flocculants have been added and mixed uniformly into the ore dispersion, however, the particular time of settling is not deemed critical and may vary widely depending upon the specific ore processed, the polymer composition employed, the polymer dosage applied and the like.

In exemplary embodiments, the process further comprises recovering the desired materials or minerals, for example, iron. Such desired minerals or materials may be in the form of a concentrate. The recovery step generally occurs after sufficient settling of the mixture. This operation can be performed according to any conventional procedure while employing any conventional equipment associated with such procedures. Typically, the procedure is decantation of the supernatant liquid, or any other known desliming technique, followed by a flotation step in which the remaining siliceous gangue is removed by froth flotation, leaving behind the iron values.

In exemplary embodiments, the selective flocculation process results in the selective flocculation of the desired mineral when compared to the flocculation of the gangue so as to facilitate separation and recovery of the desired mineral. Using the exemplary process, the flocculation of desired minerals can be performed such that very high yields of the desired material or mineral are obtained, for example at least about 70%, about 75%, about 80%, about 85%, about 90%, or about 95% recovery of the desired material or mineral, such as iron.

By “effective amount” of the selective flocculant is meant an amount of the selective flocculant that is effective in producing the desired degree of selective flocculation which, in turn, results in the desired degree of recovery of metal values, e.g., iron ore. The particular amount that is effective will vary depending upon variables such as the particular ore processed, the specific composition of the one or more selective flocculants, the degree of dispersion, the particle size, and the like. In some exemplary embodiments, the effective amount will range from about 0.1 to 2.0 pounds of selective flocculant per ton of ore processed. According to alternative exemplary embodiments, the effective amount of selective flocculant to be used in the flocculation process is about 1,000 to about 0.01 ppm, or about 500 to about 0.1 ppm of flocculant in the flocculation process. In exemplary embodiments, the effective amount of flocculant in the processes is about 250 to about 1 ppm, about 150 to about 5 ppm of flocculant, about 100 to about 10 ppm or about 80 to about 15 ppm.

In exemplary embodiments, a process for improving the grade of a desired mineral or matter comprises selectively flocculating a mixture containing the desired mineral and gangue with one or more selective flocculants described herein to produce a desirable mineral, and separating the desirable mineral concentrate from the gangue. In exemplary embodiments, the desirable mineral concentrate recovered from the processes described herein has an improved grade relative to the grade of the ore before the selective flocculation. In exemplary embodiments, the desired mineral is an iron-containing mineral, such as iron oxides or iron powder.

In exemplary embodiments, the one or more selective flocculants may be used prior to a desliming step, such as hydrocyclone desliming. In exemplary embodiments, the selective flocculants may be added to tailings streams of any of the processes described herein to enrich, or facilitate recovery of, a desired mineral from the tailings stream. Generally, “tailings” refers to the materials left over after the process of separating the valuable fraction from the uneconomic fraction. In certain embodiments, the tailings stream comprises about 10 to about 50% iron-containing compounds.

In exemplary embodiments, a process for enriching, or facilitating recovery of, a desired mineral from a tailings stream comprising the desired mineral and gangue, wherein the process comprises carrying out a flocculation process in the presence of one or more selective flocculants described herein. In exemplary embodiments, the tailings stream is a tailings stream of a desliming process. In exemplary embodiments, the tailings stream is a tailings stream of a flotation process. In exemplary embodiments, the tailings stream comprises an iron-containing mineral. In exemplary embodiments, the tailings stream comprises oxides of silica, silicates or siliceous materials. In exemplary embodiments, the process for enriching a desired mineral from a tailings stream comprises the steps of:
adding one or more exemplary selective flocculants;
agitating the mixture to distribute the one or more selective flocculants;
allowing flocs to form; and
isolating the flocs.

In exemplary embodiments, the one or more selective flocculants can be used to enrich iron-containing minerals in a tailings stream containing iron-containing ore, including magnetite, hematite, taconite or itabirite.

Other flocculants may be used in combination with the exemplary selective flocculants and are not particularly limited and include: starch such as starch derived from tapioca, corn, potato, wheat, rice and the like; starch activated by treatment with alkali; cellulose esters, such as carboxymethylcellulose and sulphomethylcellulose; cellulose ethers, such as methyl cellulose, hydroxyethylcellulose and ethyl hydroxyethylcellulose; hydrophilic gums, such as gum arabic, gum karaya, gum tragacanth and gum ghatti, alginates; starch derivatives, such as carboxymethyl starch and phosphate starch; and combinations thereof.

According to various embodiments, the amount of selective flocculation may be quantified. For example, the amount of selective flocculation may be quantified according to the percent improvement of the mineral grade, i.e., the change in percent by weight of the valuable mineral in the concentrated material compared to the material before the froth flotation process. In exemplary embodiments, use of the exemplary selective flocculant causes valuable metal grade to increase by at least about 1%, about 1.5%, about 2%, about 2.5%, about 3%, about 4%, about 5%, about 6%, about 7%, about 8%, about 8%, or about 10%. Even relatively modest amounts of improvement to the recovered metal grade may represent significant increases in production and profitability of the method over time.

In exemplary embodiments, a process for enriching an iron-containing mineral from an ore having the iron-containing material and silicate-containing gangue, includes carrying out a selective flocculation step prior to a flotation process in the presence of one or more dispersing agents.

In exemplary embodiments, the one or more dispersing agents are added at any stage of the process prior to the settling step. In certain embodiments, the one or more dispersing agents are added before or with the addition of the disclosed selective flocculating agents.

According to an exemplary embodiment, the selective flocculation process produces: a top fraction which is a gangue-enriched dispersion, for example, a silicate-enriched dispersion; and a bottom fraction which is rich in the desired mineral (underflow), for example, iron.

According to the embodiments, one or more steps may be performed prior to the selective flocculation step to prepare the ore for flocculation and flotation. For example, in one step of the process, the ore can be ground, together with water, to the desired particle size. The grain size of the ore and its degree of comingling with the silica groundmass determine the grind size to which the rock must be reduced to enable efficient separation, e.g., via subsequent desliming and froth flotation, to provide a high purity metal concentrate. An exemplified average particle size is less than about 1 mm, e.g., between about 1 and about 300 μm or between about 5 and 200

Optionally, conditioning agents such as sodium hydroxide and/or sodium silicate may be added to the grinding mill prior to grinding the crude ore. In an exemplary embodiment, sufficient water is added to the grinding mill to provide a slurry suitable for subsequent processing, as would be well understood in the art, for example, containing about 50% to about 70% solids, although this amount is understood to be not particularly limited.

In exemplary embodiments, a base or alkali pH adjuster may be added to adjust the pH of the slurry. For example, a pH adjuster may be added to the slurry to produce a pH in the range of about 6 to about 11, about 8 to about 11, about 9 to about 11, or about 10 to about 11. In certain embodiments, the pH may be adjusted to about 10.5. In exemplary embodiments, the pH of the slurry in the flocculation cell is maintained at between about 6 and about 11, or about 8 and about 11. In exemplary embodiments, the pH may be adjusted to produce optimum iron recoveries.

According to the embodiments, the selective flocculation process may include a step of adding one or more dispersing agents. For example, the dispersing agents may be added to the mixture before, after, or during the addition of the one or more selective flocculants and/or any other process agents.

In exemplary embodiments, the selective flocculation process may include a step involving conditioning or agitation of the mixture. For example, once all of the processing agents have been added to the mixture, the mixture may be further conditioned or agitated for a period of time before the settling step is carried out.

In exemplary embodiments, the selective flocculation process may be performed in a plurality of flocculation processing steps. For example, the selective flocculation process may be performed in flocculation units containing a plurality of communicating cells in series, with the first cell(s) being generally used for the rougher settling, and subsequent cell(s) being used for the more refined settling.

In exemplary embodiments, before selective flocculation treatment the ore-water slurry comprises about 20 to about 60%, or about 30 to about 50% by weight solids. In exemplary embodiments, the duration of the selective flocculation process depends upon the desired result. In exemplary embodiments, the time of selective flocculation treatment may be from about 1 to 10 minutes for each circuit. The time of the selective flocculation process may depend, at least in part, upon the gangue content, the grain size of the ore being treated and the number of flocculation cells involved.

In exemplary embodiments, the selective flocculants, compositions and processes can be used to provide higher selectivity and desired mineral recoveries, as compared to other flocculants, when used in flocculation processes. In exemplary embodiments, the flocculated mineral concentrate, e.g. hematite concentrate, that is obtained by the exemplary processes undergoes subsequent flotation processing providing a refined mineral concentrate that meets the specifications for the steel industry. In exemplary embodiments, the selective flocculants, compositions and processes can be used to maximize the iron recovery to increase production of metallic charge per unit ore fed, which in turn provides increases in production and profitability.

In exemplary embodiments, the selective flocculants, compositions and processes described herein can be used to improve the grade of iron from iron ore such that the grade of the recovered iron is at least about 55%, about 56%, about 57%, about 58%, about 59%, about 60%, about 61%, about 61%, or about 63%. In exemplary embodiments, the selective flocculants, compositions and processes described herein can be used to improve the grade of iron from iron ore such that the grade of the recovered iron is in the range of about 55% to about 64%, about 56% to about 64%, about 57% to about 64%, or about 58% to about 64%.

In exemplary embodiments, the selective flocculants, compositions and processes described herein can be used to improve the grade of iron from iron ore by at least about 0.5%, about 1%, about 1.5%, about 2%, about 2.5%, about 3%, about 3.5%, about 4%, about 4.5%, about 5%, about 5.5%, or about 6%. For example, the selective flocculants, compositions and processes described herein can be used to improve the grade of iron from iron ore with an initial iron grade of about 58% to a grade of at least about 58.5%, about 59%, about 59.5%, about 60%, about 60.5%, about 61%, about 61.5%, about 62%, about 62.5%, or about 63%.

In exemplary embodiments, the selective flocculants, compositions and processes described herein can be used to improve the grade of iron from iron ore by about 0.5% to about 7%, about 1% to about 7%, about 1.5% to about 6%, or about 4.5% to about 6%.

In exemplary embodiments, the selective flocculants, compositions and processes described herein can be used to improve the grade of iron oxide from iron ore such that the grade of the recovered iron oxide is at least about 80%, about 81%, about 82%, about 83%, about 84%, about 85%, about 86%, about 87%, or about 88%. In exemplary embodiments, the selective flocculants, compositions and processes described herein can be used to improve the grade of iron oxide from iron ore such that the grade of the recovered iron oxide is in the range of about 80% to about 90%, about 82% to about 90%, or about 82% to about 88%.

In exemplary embodiments, the selective flocculants, compositions and processes described herein can be used to improve the recovery of iron from iron ore to at least about 50%, about 60%, about 62%, about 65%, about 70%, about 75%, about 80%, about 85%, or about 90%. In exemplary embodiments, the selective flocculants, compositions and processes described herein can be used to improve the recovery of iron from iron ore such that the recovery of iron is in the range of about 50% to about 95%, about 60% to about 95%, about 70% to about 95%, or about 70% to about 93%.

In exemplary embodiments, the flocculants, compositions and processes can be used to reduce the amount of silica in the iron ore to less than about 10%, about 9%, about 8%, about 7%, about 6%, about 5%, about 4%, about 3%, or about 2%.

The following examples are presented for illustrative purposes only, and are not intended to be limiting.

### EXAMPLES

### Example 1

### Flocculation Test with Iron Ore and Exemplary Selective Flocculant Comprising Acrylamide/Hydroxyethyl Methacrylate Polymer

In this example, flocculation tests were conducted on a laboratory scale and the objective of these tests were to separate the mineral of interest (iron oxide) from gangue (SiO₂). The exemplary selective flocculant used for these experiments was an acrylamide/hydroxyethyl methacrylate copolymer comprising 0.2 mole fraction hydroxyethyl methacrylate and 0.8 mole fraction acrylamide, and having a weight average molecular weight of about 300,000 to about 500,000 Dalton. Flocculation tests were done on a laboratory scale in a 250 ml cylinder. Simulated ore/gangue mixture was prepared by combining Fe₂O₃ and SiO₂ (both from Sigma Aldrich) to produce a simulated ore/gangue mixture with about 80 wt % Fe₂O₃ (56% Fe) and about 20 wt % SiO₂. 12.5 grams of the simulated ore/gangue material were weighed and combined with sufficient water to bring the sample volume up to 250 ml. Next, a sodium silicate and polyacrylic acid dispersant (KemEcal™ TC2500 available from Kemira Chemicals, Inc.), was added and the pH was checked and adjusted to pH 9-10 with sodium hydroxide. The exemplary selective flocculant was then added in the desired amount, and the contents of the cylinder were fully mixed, in this case, by inverting and reverting the cylinder 30 times. The mixture was then allowed to settle for 10 minutes and the top layer was separated from the bottom. The layers were dried and measured by X-ray fluorescence.

The pH, flocculant concentration and dispersant concentration used in each experiment and the resulting grade and recovery values are provided in Table 1, below.

TABLE 1

| Dispersant | | Flocculant | | | | |
|---|---|---|---|---|---|---|
| Con- | | Con- | Mass | Fe₂O₃ | Fe | Fe |
| centration | | centration | Recovery | Grade | Grade | Recovery |
| mg/L | pH | mg/L | % | % | % | % |
| 20 | 9.9 | 20 | 72.96 | 84.30 | 59.01 | 76.88 |
| 80 | 9.7 | 20 | 66.56 | 84.60 | 59.22 | 70.39 |
| 120 | 9.3 | 20 | 69.68 | 84.20 | 58.94 | 73.34 |
| 120 | 9.4 | 20 | 69.20 | 85.20 | 59.64 | 73.70 |
| 40 | 9.3 | 40 | 72.08 | 88.00 | 61.60 | 79.29 |
| 120 | 9.0 | 40 | 79.52 | 84.20 | 58.94 | 83.69 |
| 120 | 9.5 | 60 | 87.04 | 85.30 | 59.71 | 92.81 |
| 40 | 9.3 | 80 | 70.40 | 85.20 | 59.64 | 74.98 |
| 20 | 9.5 | 100 | 89.04 | 83.60 | 58.52 | 93.05 |
| 40 | 9.2 | 100 | 79.36 | 86.10 | 60.27 | 85.41 |
| 80 | 9.0 | 100 | 72.96 | 85.10 | 59.57 | 77.61 |
| 120 | 9.4 | 100 | 89.44 | 82.30 | 57.61 | 92.01 |

It was observed that the exemplary selective flocculant, when used in the flocculation tests, improved the iron oxide grade from 80% to as much as 88%, the iron grade from 56.0% to as much as 61.60%.

### Example 2

### Flocculation Tests with Exemplary Selective Flocculant Comprising Acrylamide/Hydroxyethyl Methacrylate Polymer on Pure Iron Oxide or Silica

In this example, flocculation tests were conducted on a laboratory scale to assess the effect of an exemplary selective flocculant on pure iron oxide or silica samples. The exemplary selective flocculant used for these experiments was an acrylamide/hydroxyethyl methacrylate copolymer comprising 0.2 mole fraction hydroxyethyl methacrylate and 0.8 mole fraction acrylamide, and having a weight average molecular weight of about 300,000 Dalton.

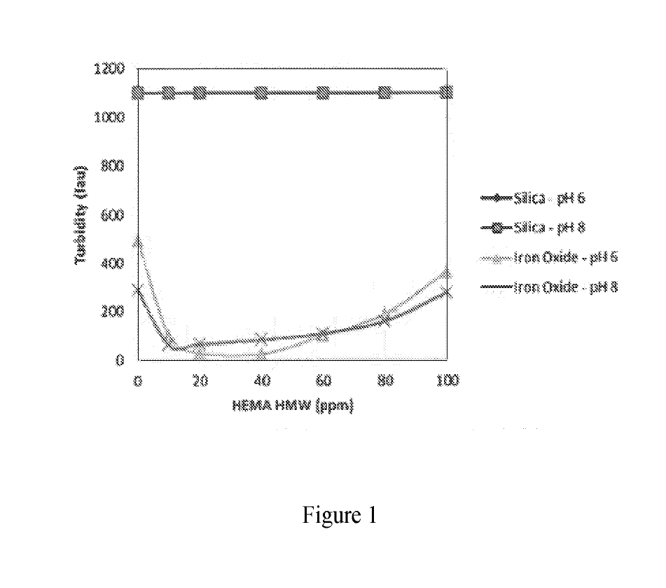

In each test 5 grams of pure iron oxide (the size of 80% of the particles was less than 5 micron) or silica (the size of 80% of the particles was between about 1 to about 5 micron) were combined with sufficient water to bring the sample volume up to 250 ml. Next, the pH was checked and adjusted to 6 or 8 with sodium hydroxide. The exemplary selective flocculant was then added in the desired amount and the contents of the cylinder were fully mixed by inverting and reverting the cylinder 30 times. The mixture was then allowed to settle for 10 minutes and the top layer was separated from the bottom. The turbidity of the top layer was analyzed with a Hach Colorimeter. The turbidity analysis for the sample is shown in FIG. 1.

Lower turbidity indicates better flocculation. The results show that the exemplary flocculant is capable of flocculating the iron oxide at pH 6 and pH 8 for a range of dosages and that the exemplary flocculant does not effectively flocculate the silica.

### Example 3

### Flocculation Test with Iron Ore and Exemplary Selective Flocculant Comprising Acrylamide/Acrylic Acid/Hydroxyethyl Methacrylate Polymer

In this example, flocculation tests were conducted on a laboratory scale to separate the mineral of interest (iron oxide) from gangue (SiO₂) in an aqueous ore/gangue mixture. The exemplary selective flocculant used for these experiments was an acrylamide/acrylic acid/hydroxyethyl methacrylate copolymer comprising 75 mole fraction acrylamide, 5 mole fraction acrylic acid, and 20 mole fraction hydroxyethyl methacrylate, and having a weight average molecular weight of about 300,000 to about 500,000 Dalton (referred to below as AMD/AA/HEMA).

Flocculation tests were done on a laboratory scale in a 250 ml cylinder. The aqueous ore/gangue mixture was obtained from a desliming overflow sample from a Brazilian iron mine. The aqueous ore/gangue mixture contained about 83 wt % Fe₂O₃ (58% Fe) and about 15 wt % SiO₂. To a 250 mL sample of the aqueous ore/gangue mixture was added 3 mL of 1% solution of a sodium silicate and polyacrylic acid dispersant (KemEcal™ TC2500 available from Kemira Chemicals, Inc.). The pH was checked and adjusted to pH 9-10 with sodium hydroxide. The exemplary selective flocculant (AMD/AA/HEMA) or corn starch was then added in the desired amount, and the contents of the cylinder were fully mixed by inverting and reverting the cylinder 30 times. The mixture was then allowed to settle for 10 minutes and the top layer was separated from the bottom. The layers were dried and measured by X-ray fluorescence.

The pH, flocculant concentration and dispersant concentration used in each experiment, the resulting iron grade in the concentrate and tailings, and the iron recovery values are provided in Table 2, below.

TABLE 2

| Flocculant Type | AMD/AA/HEMA | Corn Starch |
|---|---|---|
| Flocculant Dosage (ppm) | 120 | 120 |
| Dispersant Dosage (ppm) | 120 | 120 |
| pH | 9.7 | 9.7 |
| Mass settled (%) | 46.63 | 62.94 |
| Fe Grade in concentrate (%) | 63.21 | 61.25 |
| Fe Grade in tailings (%) | 56.84 | 57.05 |
| Fe recovery (%) | 50.72 | 64.58 |

The results show that the flocculant test using the exemplary selective flocculant AMD/AA/HEMA, produced an iron concentrate with a higher iron grade than was achieved with a similar test using cornstarch as the selective flocculant. The flocculation tests using the exemplary selective flocculant improved the iron grade from 58% to as much as 63.21%. It was also observed that the AMD/AA/HEMA flocculant provided a more clear separation of the solids from the solution in settling tests than the corn starch.

In the preceding procedures, various steps have been described. It will, however, be evident that various modifications and changes may be made thereto, and additional procedures may be implemented, without departing from the broader scope of the exemplary procedures as set forth in the claims that follow.

1. A selective flocculant comprising a polymer comprising: a) recurring units of one or more acrylamide monomers; b) recurring units of one or more monomers selected from hydroxyalkyl alkylacrylate, allyloxyalkyldiol, allyloxyethanol, trimethylolpropane allyl ether, and 2-hydroxy ethyl acrylate; and optionally, c) recurring units of one or more acrylic acid monomers.

2. The selective flocculant of claim 1, wherein the polymer comprises recurring units of one or more hydroxyalkyl alkylacrylate monomers.

3. (canceled)

4. (canceled)

5. (canceled)

6. The selective flocculant of claim 2, wherein the one or more hydroxyalkyl alkylacrylate monomers comprise hydroxyethyl methylacrylate.

7. (canceled)

8. (canceled)

9. The selective flocculant of claim 6, wherein the one or more selective flocculants comprises a polymer consisting essentially of: a) recurring units of one or more acrylamide monomers; b) recurring units of hydroxyethyl methylacrylate monomers; and c) recurring units of one or more acrylic acid monomers.

10. (canceled)

11. A composition comprising: one or more selective flocculants according to claim 1; and a slovent.

12. The composition of claim 11, wherein the solvent is water.

13. A process for enriching a desired mineral from an ore comprising the desired mineral and gangue, wherein the process comprises carrying out a flocculation process in the presence of one or more selective flocculants according to claim 1.

14. The process of claim 13, wherein the desired mineral is an iron-containing mineral.

15. The process of claim 13, wherein the gangue comprises oxides of silica, silicates or siliceous materials.

16. The process of claim 13, wherein the flocculation process comprises the steps of:
mixing a ground ore with a solvent to form a mixture;
adding one or more selective flocculants according to any one of claims 1-10 to the mixture;
agitating the mixture to distribute the flocculant;
allowing flocs to form; and
isolating the flocs.

17. The process of claim 13, wherein the one or more selective flocculants is added in the form of a composition comprising the selective flocculant and a solvent.

18. The process of claim 17, wherein the solvent is water.

19. The process of claim 13, wherein the process improves the grade of iron from iron ore such that the grade of the recovered iron is in the range of about 57% to about 64%.

20. The process of claim 11, wherein the process improves the grade of iron oxide from iron ore such that the grade of the recovered iron oxide is in the range of about 82% to about 88%.

21. The process of claim 13, wherein the one or more selective flocculants are added to tailings streams.

22. A process for enriching, or facilitating recovery of, a desired mineral from a tailings stream comprising the desired mineral and gangue, wherein the process comprises carrying out a flocculation process in the presence of one or more selective flocculants according to claim 1.

23. The process of claim 22, wherein the tailings stream is a tailings stream of a desliming process.

24. The process of claim 22, wherein the tailings stream is a tailings stream of a flotation process.

25. The process of claim 22, wherein the tailings stream comprises an iron-containing mineral.

26. The process of claim 22, wherein the process comprises the steps of:
adding one or more exemplary selective flocculants;
agitating the mixture to distribute the one or more selective flocculants;
allowing flocs to form; and
isolating the flocs.
